(19) United States
(12) Patent Application Publication
(10) Pub. No.: US 2025/0303604 A1
(43) Pub. Date: Oct. 2, 2025

(54) PROCESSING DEVICE FOR CUTTING AND PUNCHING FLAT MATERIAL, SUCH AS SHEET METAL, AND PUNCHING ASSEMBLY THEREFOR

(71) Applicant: EVOBEND GmbH, Ainring (DE)

(72) Inventor: Nikolaus Franz DUSCHER, Bergheim near Salzburg (AU)

(73) Assignee: EVOBEND GmbH, Ainring (DE)

(21) Appl. No.: 18/868,118

(22) PCT Filed: May 24, 2023
(86) PCT No.: PCT/EP2023/063925

§ 371 Date: Nov. 21, 2024

(30) Foreign Application Priority Data
May 24, 2022 (DE) 10 2022 113 094.0

(51) Int. Cl. B26D 9/00; B26D 5/04; B26D 7/01; B26F 1/38; B26F 1/44

(52) U.S. Cl. CPC B26D 9/00; B26D 5/04; B26D 7/015; B26F 1/384; B26F 1/44

(57) ABSTRACT

A machining device for cutting and punching flat material, such as sheet metal, is disclosed. A base includes a support table for the flat material. The base defines a feed direction in which the flat material is configured to be fed into the machining device. A first cutting device is configured to cut the flat material transversely to the feed direction. A second cutting device is configured to cut the flat material in the feed direction. A separative machining unit is configured to be displaceable in the machining device relative to the base transversely to the feed direction. The separative machining unit is configured to subject the flat material to separative machining in sections.

The present invention relates to a machining device for cutting and punching flat material, such as sheet metal, comprising:
a base including a support table for the flat material, the base defining a feed direction in which the flat material can be fed into the machining device,
a first cutting device configured to cut the flat material transversely to the feed direction, and
a second cutting device configured to cut the flat material in the feed direction.

Such machining devices are known from the prior art in the field of sheet metal machining. It is common practice to feed flat material, such as sheet metal, into such machining devices to cut it longitudinally and transversely.

It is also known in the art to subject the flat material to punching during sheet metal machining. This means that a suitable punching tool is used to cut out portions of the sheet material that has already been cut or is to be cut, or to cut it in sections. Such punching is hence performed in the process cycle before or after machining using the machining device described in more detail above for cutting the flat material. The purpose of punching may be to clamp certain recesses in the sheet material. However, the purpose may also be to cut the sheet material at least in sections along any contour, which is achieved by performing repeated punching operations along the desired contour using a suitable punching tool.

For this type of punching, specially configured punching machines are used. They usually comprise a controllable punching unit. A corresponding punching machine having such a punching unit is described, for example, in European patent EP 1 748 853 B1. According to the teachings of this patent, a punching unit is provided which is configured with a double-spindle drive comprising drive spindles oriented in opposite directions. A punching tool is optionally rotated via the double-spindle drive and thus aligned in its angular position or then subjected to a stroke movement in the desired alignment to perform the punching operation. This is done in such a way that the two drive spindles are each controlled by a drive motor. Control is exerted in such a way that the stroke movement is achieved by driving the two drive spindles in opposite directions about a stroke axis to perform the punching operation. If the punching tool is to be rotated, the two drive spindles are driven in the same direction about the stroke axis. This device is further configured so that a tool support for receiving the punching tool is directly coupled to the double-spindle drive. This means that this punching unit can only be used to a limited extent, namely to the extent permitted by the respective tool received in the tool support.

Furthermore, punching units in which the stroke movement for punching is initiated hydraulically are known in the art.

It is well known that laser machining or waterjet cutting can also be used to machine flat material.

It is an object of the present invention to provide a machining device of the type discussed at the outset, which combines the process of separating, in particular punching, the flat material in sections with cutting it longitudinally and transversely. It is another object of the present invention to provide a punching unit for such a machining device.

This object is achieved with a machining device of the type discussed at the outset, which further comprises a separative machining (cutting) unit configured to be displaceable in the machining device relative to the base transversely to the feed direction, wherein the separative machining unit is configured to subject the flat material to separative machining or punching in sections.

The invention thus provides for the combination of the machining steps of transverse cutting and longitudinal cutting with local separative machining, for example in the form of punching, in a single machining device, i.e. in a single machine, by providing the separative machining unit. In addition to the two cutting devices, the punching unit is provided in the machine, which makes it possible to carry out local punching and separative machining on the flat material in one and the same machine. The invention thus achieves a compact machine for carrying out all the separative machining steps normally required when machining flat material, in particular sheet metal.

In the context of the present invention, where reference is made to a support table, this does not necessarily mean that it is a table with a planar extended table top. Rather, this means that the flat material can be introduced into the machining device via an extended support and fed to the other components of the machining device. This support or the support table may, for example, be formed by a large number of rollers or roller conveyors.

It may be provided that the support table has guide members for aligning the longitudinal material. In addition, the support table may also have molding rollers to straighten the flat material, i.e. to smooth out any deformations, such as unevenness, local bulges, curvatures, etc.

One embodiment of the invention provides that a guide portal is provided on the base, which is arranged transversely to the support table, the guide portal having a guide device which makes the separative machining unit displaceable in a guided manner relative to the base. The separative machining unit is thus displaceable along the guide device on the guide portal so that it can machine any location of the flat material as the latter is fed through the machine. It is preferable for the guide device to have a linear guide.

In one embodiment of the invention, it may be provided that the flat material is displaceable on the support table relative to the base in the feed direction with a feed device. Such displacement may take place by means of a displacement device, e.g. driven feed rollers or the like. Furthermore, the flat material can be stopped and fixed in a certain desired position. It may be provided that the base has a fixing device for temporarily fixing the flat material on the support table.

In one embodiment of the invention, it may be provided that the guide portal is configured to be displaceable relative to the base in the feed direction. In other words, the guide portal itself may be displaceable relative to the base, for example such that it can be moved together with the flat material in the feed direction relative to the base within a specific displacement range. However, it may also be possible to temporarily stop the flat material and move the guide portal relative to the flat material parallel to the intended feed direction to perform certain machining steps. This makes it possible, for example, to cut any contour in the flat material. Furthermore, the guide portal may be displaceable transversely to the feed direction relative to the base.

In one embodiment of the invention, it may be provided that the first cutting device comprises a guillotine shearing device or a rotary shearing device. Typically, such cutting devices are used for cutting the flat material in the transverse direction, i.e. transversely to the feed direction. It may further be provided that the second cutting device comprises a circular blade device or a rotary shearing device. Such cutting devices are usually used for cutting the flat material in the longitudinal direction, i.e. parallel to the feed direction.

As already discussed at the outset, there are various options to design the separative machining unit. It is important that the separative machining unit is suitable for carrying out localized separative machining operations in the flat material, i.e. producing locally defined recesses in the flat material or splitting the flat material along a predetermined profiled line. In this context, it may be provided that the separative machining unit is configured with a laser machining unit and/or a punching unit. The separative machining unit may further be designed as a waterjet cutting machining head. If designed as a laser machining unit, the separative machining unit may have laser optics that provide a laser beam that can be focused onto the flat material. If designed as a punching unit, the separative machining unit is equipped with at least one punching tool.

In this case, it may be provided that the punching unit is configured as a hydraulic or/and mechanical punching unit. In the case of a hydraulic punching unit, the stroke movement is achieved by controlling a hydraulic control system. In the case of a mechanical punching unit, the stroke movement is achieved mechanically, for example with a spindle drive. Moreover, a mechanical punching unit may also have a spline drive, i.e. the stroke movement can be achieved by displacing different spline surfaces in relation to each other.

To ensure that punching is as flexible and multi-functional as possible, one embodiment of the invention provides for the punching unit to comprise a plurality of punching tools that can be optionally selected for machining the flat material. It is thus possible to set up a tool receptacle with a plurality of punching tools, wherein in each case the required punching tool is controllable via a separate reciprocating piston that can selectively control one of the punching tools held in the tool receptacle by twisting relative to the tool receptacle and use it to perform a punching operation. The other punching tools provided in the tool receptacle remain passive.

According to the invention, it may be provided that the mechanical punching unit is configured with a motor-driven double-spindle arrangement with spindle drives rotating in opposite directions and a drive control, wherein a force output member is selectively displaceable in a stroke direction perpendicular to the feed direction, in particular perpendicular to a main direction of extension of the flat material, and/or twistable relative thereto. In such an embodiment, the force output member can be used to control a punching unit having a plurality of punching tools. By selecting the angular position of the force output member, the reciprocating piston of a tool assembly of the punching unit comprising the plurality of punching tools can be twisted to selectively control the desired punching tool.

As an alternative to a double-spindle arrangement with spindle drives rotating in opposite directions, in one embodiment of the invention, it is also possible to equip the punching unit with only one spindle which may be configured to rotate either clockwise or anti-clockwise and which may be coupled to a shaft guide that is optionally locked against twisting. Such components are also known as lifting/rotary modules.

The invention further relates to a punching unit for punching flat material, in particular a machining head for a machining device of the type previously described, wherein the machining head comprises:
a housing defining a stroke axis;
a mechanical or hydraulic lifting device comprising a force output member;
a tool receptacle for receiving at least one cutting or punching tool, which is mounted in the housing so as to be rotatable about an axis of rotation;
at least one cutting or punching tool which can be received in the tool receptacle and is displaceable in the direction of the stroke axis along a tool longitudinal axis, wherein the cutting or punching tool is displaceable along its tool longitudinal axis via the force output member;
a rotatable positioning device for rotatably positioning the at least one cutting or punching tool; and
a die unit which is configured to interact with the at least one cutting or punching tool and can be aligned in accordance with its rotatable positioning.

Such a punching unit allows flexible punching of flat material. The movement is performed through the mechanical or hydraulic lifting device. The tool receptacle can be twisted separately relative to the lifting device through the rotatable positioning device. This allows the tool selected for cutting or punching to be aligned at any angle. If a number of cutting or punching tools are provided, they can also be controlled separately. As is well known, to achieve a high-quality machining result, a die unit is provided to receive and guide the cutting or punching tool during punching.

In one embodiment of the punching unit according to the invention, it may be provided that the rotatable positioning device is configured to rotatably position the cutting or punching tool about its tool longitudinal axis and/or about the stroke axis.

In the punching unit according to the invention, it may further be provided that the lifting device is configured with a hydraulic piston that displaces the force output member in the lifting device by at least a predetermined stroke distance.

An advantageous embodiment of the punching unit according to the invention provides that the lifting device is configured with a spindle arrangement, in particular with a double-spindle arrangement, wherein the double-spindle arrangement is equipped with a first spindle drive and a second spindle drive. The first and second spindle drives may have drive spindles configured to rotate in opposite directions, wherein in first and second spindle drives that are rotatably driven in the same direction, the force output member can be positioned rotatably about the stroke axis, wherein in first and second spindle drives that are rotatably driven in opposite directions, the force output member is displaceable along the stroke axis in the stroke direction.

In this embodiment of the punching unit according to the invention, it may further be provided that the tool receptacle comprises a turret with a plurality of cutting or punching tools received therein, each of the cutting or punching tools being selectively activatable for machining the flat material. One embodiment of this variant of the invention further provides that the force output member comprises a coupling member that is arranged eccentrically relative to the stroke axis and can optionally be positioned rotatably about the stroke axis, wherein the respective cutting or punching tool can be activated for machining the flat material in accordance with the rotational position of the coupling member about the stroke axis while cutting or punching tools that have not been activated remain passive.

In addition, this variant of the invention may provide that the tool receptacle is assigned a reciprocating piston which can be coupled to the force output member and which makes the respectively activated cutting or punching tool displaceable along its tool longitudinal axis in the stroke direction.

To position the respective punching tool in a predetermined angular position, one embodiment of the machining head according to the invention provides for a rotary drive to be assigned to the tool receptacle, with which the tool receptacle can be positioned rotatably about the stroke axis relative to the housing, wherein the alignment of the at least one cutting or punching tool of the stroke axis can be changed in accordance with the rotational position of the tool receptacle.

Further, one embodiment of the punching unit according to the invention provides for a rotary drive to be assigned to the die unit, with which a die that receives the respectively activated cutting or punching tool and is complementary to the activated cutting or punching tool can be positioned rotatably about the stroke axis relative to the housing, wherein the die can be positioned in accordance with the alignment and positioning of the activated cutting or punching tool of the stroke axis.

Below, the invention is explained by way of example with reference to figures. In the drawings:

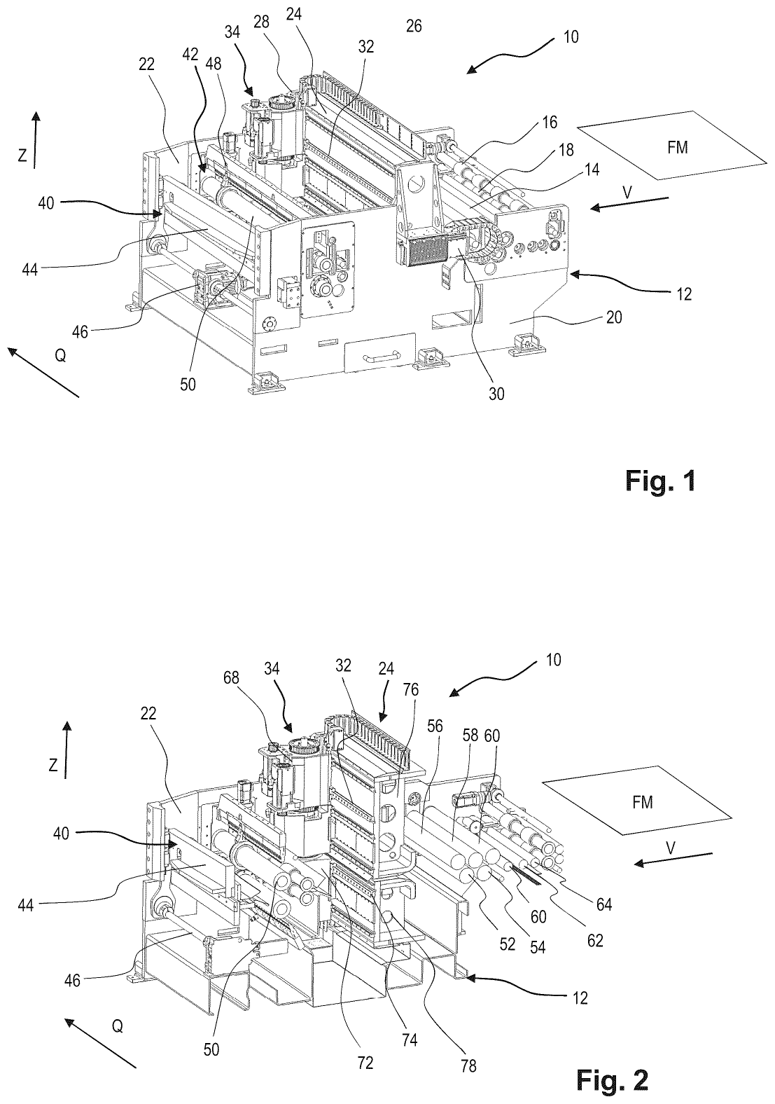

FIG. 1 is a spatial representation of a machining device according to the invention;

FIG. 2 is a spatial sectional view along a vertical sectional plane of the machining device according to the invention in the feed direction;

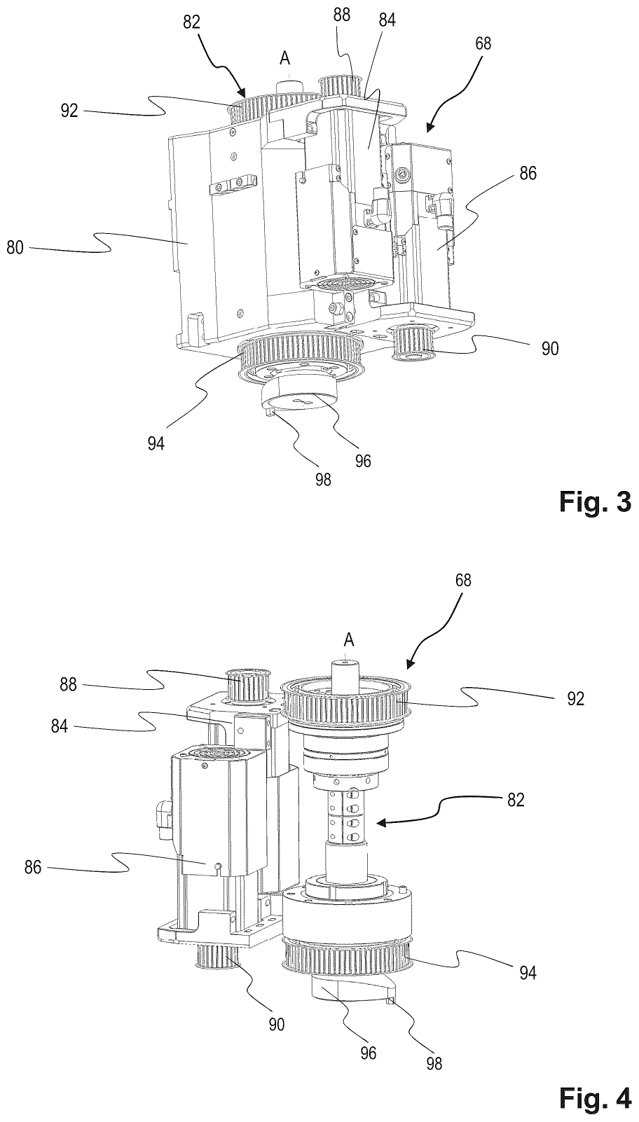

FIG. 3 is a spatial representation of an upper part of a punching unit according to the invention;

FIG. 4 is a spatial representation of the upper part of the punching unit according to the invention, with part of the housing being omitted to make the double-spindle arrangement visible;

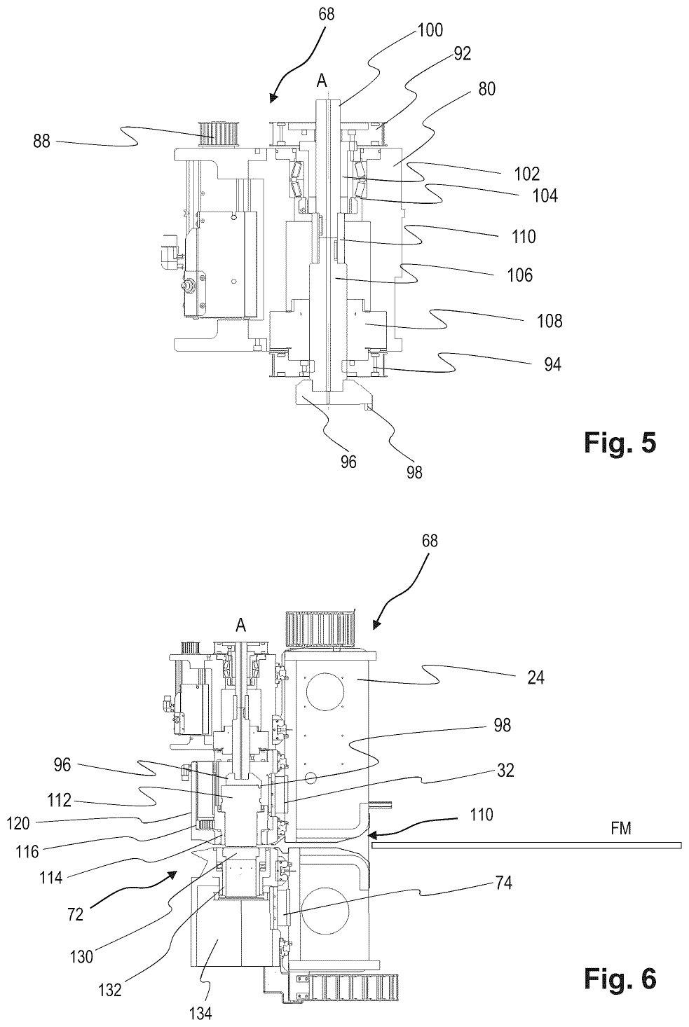

FIG. 5 is a sectional view along the stroke axis of the upper part of the punching unit according to the invention;

FIG. 6 is a detail of the machining device according to the invention, showing a feeder upstream of the punching unit with respect to the feed direction as well as a die device of the punching unit in a section containing an axis;

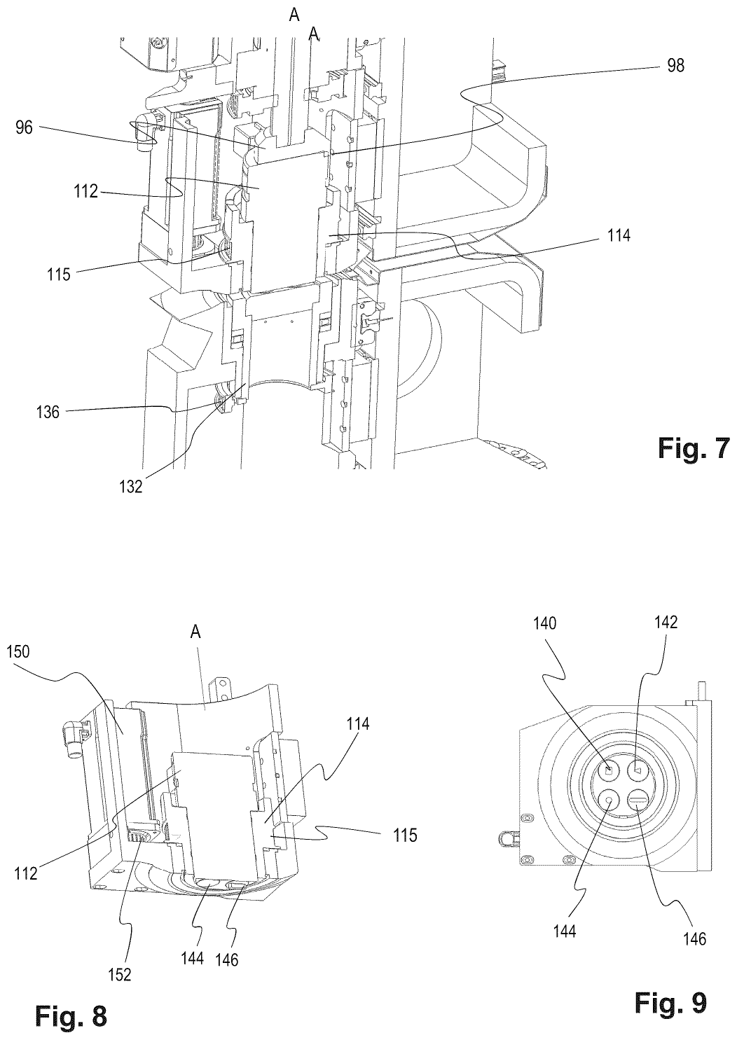

FIG. 7 is a spatial view showing a detail of FIG. 6 to illustrate the interaction between the individual components of the punching unit;

FIGS. 8 and 9 are spatial partial sectional views illustrating the tool receptacle;

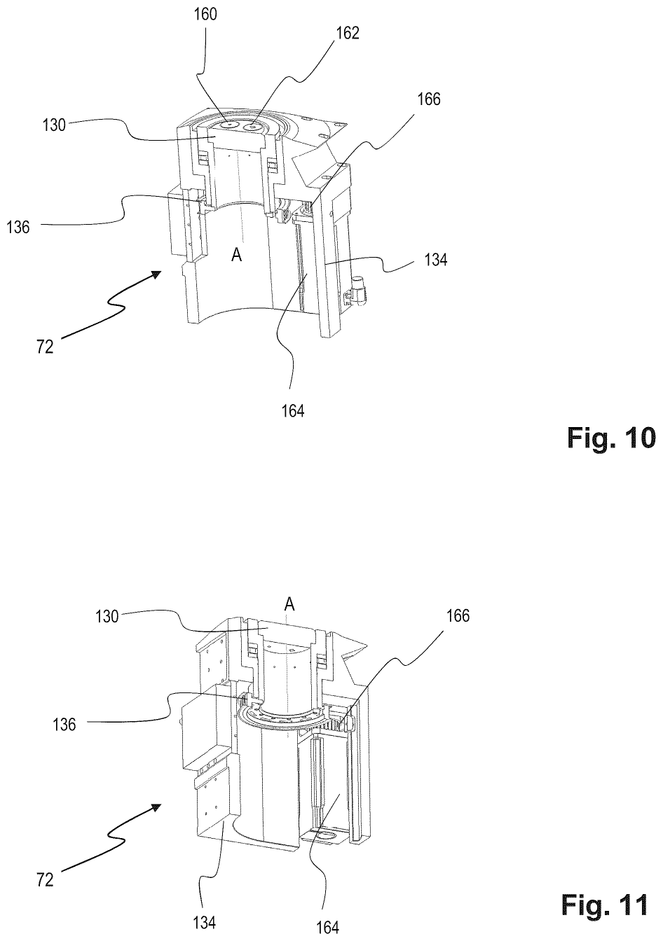

FIG. 10 is a spatial sectional view of the die device, containing an axis; and

FIG. 11 is another spatial sectional view of the die device, containing an axis.

FIG. 1 is a spatial representation of a machining device according to the invention, generally referred to as 10. It comprises a base 12 which is firmly attached to a floor and which includes a support table 14 on which the flat material FM can be placed and displaced in a feed direction V. Drive rollers 16, 18 which can be driven and between which the flat material FM can be passed are used for displacement. The flat material FM may, for example, be a sheet material. The base 12 further comprises two side walls 20, 22 on which the support table 14 and the various drive rollers 16, 18 are mounted.

Furthermore, a guide portal 24 is attached to the two side walls 20, 22, which extends transversely to the support table 14 above and below the plane along which the flat material FM is guided. This guide portal 24 is attached for linear displacement along a linear guide 30 relative to the base 12 by means of lateral portal holders 26, 28. The guide portal 24 can thus be displaced to a certain extent relative to the base 12 in the feed direction V by means of the two portal holders 26, 28. A first linear guide 32 is attached to the guide portal 24 in the transverse direction Q. This linear guide 32 serves to displace a punching unit 34, which will be explained in detail below, relative to the guide portal 24 in the transverse direction Q and thus transversely to the base 12.

FIG. 1 further shows two cutting devices. A first cutting device 40 is configured as a guillotine shearing device and serves to cut the flat material in the transverse direction Q. A second cutting device 42 is configured as a rotary shearing device and serves to cut the flat material FM in the longitudinal direction, i.e. in the feed direction V. The cutting device 40 is attached so as to be stationary, with a blade 44 being displaceable in the height direction Z by means of a linear guide. An eccentric drive 46 is provided for this purpose. In the cutting device 42, a rotary blade 48 is provided so as to be linearly displaceable on a guide cylinder 50.

Details of this machine are also visible in the illustration of FIG. 2 in which the front side wall 20 of FIG. 1 was cut away for a better view of the inside of the machine. It can be seen that a series of guide rollers 52, 54, 56, 58, 60, 62, 64 for guiding, positioning, clamping and displacing the flat material FM are mounted in the base 12 or on the side walls 20, 22. Further, it can be seen that the portal 24 is displaceable along the linear guide 30 and has a further linear guide 66. The portal carries the punching unit 34 which comprises a machining head 68 and a die unit 72. Their mode of operation will also be described in detail below. A further linear guide 74 is provided to guide the die unit 72. It allows synchronous displacement of the machining head 68 and the die unit 72 in the transverse direction along the portal 24 and the further guide unit 70.

It should also be noted that the portal 24 is configured in two parts. It comprises an upper portion 76 and a lower portion 78 that are separated from each other by a guide gap 79. The flat material FM is passed through the guide gap 79.

A spatial representation of an upper part of the machining head 68 is now shown in FIG. 3. It comprises a housing 80 which houses a double-spindle drive 82 with drive spindles oriented in opposite directions. FIG. 4 also shows the upper part of the machining head 68, but from a different perspective, with part of the housing 80 omitted. In addition to the double-spindle drive 82, the machining head 68 has two drive motors 84, 86. These two drive motors are each provided with an output gear 88, 90, each of which can drive corresponding drive gears 92, 94 of the double-spindle drive 82 via a toothed belt (not shown). FIGS. 3 and 4 further illustrate a force output member 96 with an eccentrically protruding lug 98. For further explanation, it is also pointed out that the double-spindle drive 82 has an axis of rotation A.

FIG. 5 is a section, which contains an axis, of the machining head 68 along the axis A. It illustrates the force output member 96 with the protruding lug 98. A first spindle 100 is received in a first spindle sleeve 102. The spindle sleeve 102 is rotatably driven by means of the output gear 88 and the drive gear 92. It is rotatably supported in the housing 80 about the axis A by means of a bearing arrangement 104. A second spindle 106 is received in a second spindle sleeve 108. The spindle sleeve 108 is rotatably driven by means of the output gear 90 (not shown) and the drive gear 94. The spindles are coupled to each other by means of a coupling part 110. In principle, the mode of operation is known from the prior art, for example from document EP 1 748 853 B1. The two drive motors 84, 86 are controllable so as to be able to drive the two drive gears 92, 94 with opposite or the same orientation, i.e. with opposite or the same direction of rotation. If both spindle sleeves 102 and 108 rotate in the same direction, this only results in a rotational movement of the force output member 96 and thus twisting of the lug 98 about the axis A, so that the angular position of the eccentrically protruding lug 98 about the axis of rotation A changes. If both spindle sleeves 102 and 108 rotate in opposite directions, this results in a stroke movement of the spindle 106 and thus a stroke movement of the force output member 96 along the axis A in the stroke direction.

In FIG. 6, the machining head 68 is now coupled to the portal 24 together with the die unit 72 which is attached to the linear guide 74 of the lower part of the portal 24. It can be seen that the portal 24 defines, in its upper and lower areas, a conically tapering inlet area 110 in the form of a gap for the flat material FM. This ensures that the flat material FM is guided into the area where the machining head 68 and the die unit 72 interact in a predetermined orientation. It can also be seen that the force output member 96 of the machining head 68 is coupled to a punching tool assembly 112. The punching tool assembly 112 is fixedly received in an assembly carrier 114 but can be removed therefrom for maintenance or replacement. The assembly carrier 114 is rotatably displaceable relative to a housing 120 by means of a rotary drive 116. This means that the punching tool assembly 112 can be twisted about the axis A relative to the housing 120 as required.

In the upper part of FIG. 6, it can also be seen that the punching tool assembly 112 is coupled to the protruding lug 98 of the force output member 96. The lug 98 engages with a corresponding recess on a reciprocating piston (not shown) of the punching tool assembly 112. By twisting the lug 98 of the force output member 96, the reciprocating piston of the punching tool assembly 112 can be twisted therein. However, when the force output member 96 of the machining head 34 is displaced in the direction of the axis A to perform a stroke movement, the reciprocating piston of the punching tool assembly 112 can be displaced correspondingly in the axial direction to achieve a stroke movement of a single punching tool. This will be explained in detail below.

FIG. 6 also shows the die unit 72. It comprises a die plate 130 that is accommodated in a rotatable die carrier 132. The die carrier 132 is supported in a housing 134 and twistable by means of a separate rotary drive which is controlled synchronously with the rotary drive 116.

FIG. 7 again shows in detail the arrangement with respect to the coupling of the force output member 96 to the punching tool 112. It can be seen how the lug 98 engages with the reciprocating piston (not shown) of the punching tool assembly 112. FIG. 7 further shows that the carrier 114 for the punching tool assembly 112 is provided with external toothing 115 so that it can be rotatably driven. In addition, FIG. 7 shows that the carrier 132 is also provided with external toothing 136 so that the die plate 130 is displaceable with the carrier 132 about the axis A.

FIGS. 8 and 9 show further details with respect to the punching tool assembly 112. In particular, the bottom view of FIG. 9 shows that the punching tool assembly 112 comprises four different punching tools, i.e. a substantially square punching tool 140, a triangular punching tool 142, a circular punching tool 144, and an elongate punching tool 146. In the perspective partial sectional view of FIG. 8, only the two punching tools 144 and 146 are shown. Each of the four punching tools can be specifically controlled by twisting the reciprocating piston of the punching tool assembly 112 by means of the lug 98 of the force output member 96 so that it is aligned with the punching tool to be selected. A stroke movement of the force output member 96 then specifically results in the stroke movement of the selected punching tool, for example the elongate punching tool 146, while all other punching tools 140, 142, 144 remain passive in this example.

FIG. 8 further shows a drive motor 150 including an output gear 152 which interacts with the drive gear 115 on the carrier 114 for the punching tool assembly 112. Accordingly, a separate drive is provided for twisting the punching tool assembly 112 so that the punching tool 146 selected in the example can be brought to any angular position relative to the axis A. Finally, the die unit 72 including the die plate 130 are shown in FIGS. 10 and 11. The die plate 130 comprises die recesses which are complementary to the respective profile of the punching tools 140, 142, 144 and 146, only two of which are shown in FIG. 10, namely the two die recesses 160, 162. Furthermore, FIGS. 10 and 11 show a drive motor 164 including an output gear 166 which is configured to rotatably drive the drive gear 136 and thus the die carrier 132 via a toothed belt which is not shown. As a result, the individual die recesses in the die plate 130 can also be twisted about the axis A to any desired angular position. It is understood that the twisting of the die plate 130 is synchronized and aligned with the twisting of the punching tool assembly 130 to keep the selected punching tool 140, 142, 144 or 146 correctly aligned with the respective recess in the die plate 130.

The invention enables the flat material FM to be cut both in the transverse direction Q and in the feed direction V by means of the two cutting devices 40 and 42. Furthermore, the machining head 68 and the associated die unit 72 can be used to punch the flat material FM as desired and cut it in sections, for example with the elongate punching tool 146. The punching operation can be assisted by the fact that the entire portal 24 including the machining head 68 and associated die unit 72 is also displaceable along the linear guide 30. This makes it possible, for example, to fix the flat material FM for a specific machining operation in the base relative to the feed direction V while performing a punching operation in a specific area of the flat material FM. Since in the embodiment shown, the machining head 68 is configured with a double-spindle drive with drive spindles rotating in opposite directions, the machining head 68 may be configured to be relatively self-sufficient. It only needs to be powered and connected to the control unit. For example, there is no need for supply lines for a hydraulic system or the like. In addition, the machining head 68 has a sturdy design. The use of a punching tool assembly 112 with a plurality of punching tools offers greater flexibility and, in particular, considerable advantages over the document EP 1 748 843 B1 discussed at the outset.

All in all, the device according to the invention is a compact machine that both cuts flat material FM and performs punching operations.

1. A machining device for cutting and punching flat material, such as sheet metal, comprising:
a base including a support table for the flat material, the base defining a feed direction in which the flat material is configured to be fed into the machining device,
a first cutting device configured to cut the flat material transversely to the feed direction, and
a second cutting device configured to cut the flat material in the feed direction,
wherein the machining device further comprises a separative machining unit configured to be displaceable in the machining device relative to the base transversely to the feed direction, wherein the separative machining unit is configured to subject the flat material to separative machining in sections.

2. The machining device of claim 1, wherein a guide portal is provided on the base, which is arranged transversely to the support table, the guide portal having a guide device which makes the separative machining unit displaceable in a guided manner relative to the base, the guide device in particular comprising a linear guide.

3. The machining device of claim 2, wherein the guide portal is configured to be displaceable relative to the base in the feed direction.

4. The machining device of claim 3, wherein the flat material is displaceable on the support table relative to the base in the feed direction with a feed device.

5. The machining device of claim 1, wherein the base has a fixing device for temporarily fixing the flat material on the support table.

6. The machining device of claim 1, wherein the first cutting device comprises a guillotine shearing device or a rotary shearing device.

7. The machining device of claim 1, wherein the second cutting device comprises a circular blade device or a rotary shearing device.

8. The machining device of claim 1, wherein the separative machining unit is configured with a laser machining unit and/or a punching unit.

9. The machining device of claim 8, wherein the punching unit is configured as a hydraulic or/and mechanical punching unit.

10. The machining device of claim 8, wherein the punching unit comprises a plurality of punching tools configured to optionally selected for machining the flat material.

11. The machining device of claim 10, wherein the mechanical punching unit is configured with a motor-driven double-spindle arrangement with spindle drives rotating in opposite directions and a drive control, wherein a force output member is selectively displaceable in a stroke direction perpendicular to the feed direction, in particular perpendicular to a main direction of extension of the flat material, and/or twistable relative thereto.

12. A punching unit for punching flat material, having a machining head for a machining device, the machining head comprises:
a housing defining a stroke axis;
a mechanical or hydraulic lifting device comprising a force output member;
a tool receptacle for receiving at least one cutting or punching tool, the tool receptacle mounted in the housing so as to be rotatable about an axis of rotation;
at least one cutting or punching tool configured to be received in the tool receptacle and is displaceable in the direction of the stroke axis along a tool longitudinal axis, wherein the cutting or punching tool is displaceable along its tool longitudinal axis via the force output member;
a rotatable positioning device for rotatably positioning the at least one cutting or punching tool; and
a die unit configured to interact with the at least one cutting or punching tool and configured to be aligned in accordance with its rotatable positioning.

13. The punching unit of claim 12, wherein the rotatable positioning device is configured to rotatably position the cutting or punching tool about its tool longitudinal axis and/or about the stroke axis.

14. The punching unit of claim 12, wherein the lifting device is configured with a hydraulic piston that displaces the force output member in the lifting device by at least a predetermined stroke distance.

15. The punching unit of claim 12, wherein the lifting device is configured with a spindle arrangement, in particular with a double-spindle arrangement, wherein the double-spindle arrangement is equipped with a first spindle drive and a second spindle drive, wherein the first and second spindle drives have drive spindles configured to rotate in opposite directions, wherein in first and second spindle drives that are rotatably driven in the same direction, the force output member is configured to be positioned rotatably about the stroke axis, wherein in first and second spindle drives that are rotatably driven in opposite directions, the force output member is displaceable along the stroke axis in the stroke direction.

16. The punching unit of claim 15, wherein the tool receptacle comprises a turret with a plurality of cutting or punching tools received therein, each of the cutting or punching tools being selectively activatable for machining the flat material.

17. The punching unit of claim 16, wherein the force output member comprises a coupling member that is arranged eccentrically relative to the stroke axis and configured to optionally be positioned rotatably about the stroke axis, wherein the respective cutting or punching tool is configured to be activated for machining the flat material in accordance with the rotational position of the coupling member about the stroke axis while cutting or punching tools that have not been activated remain passive.

18. The punching unit of claim 16, wherein the tool receptacle is assigned a reciprocating piston configured to be coupled to the force output member and which makes the respectively activated cutting or punching tool displaceable along its tool longitudinal axis in the stroke direction.

19. The punching unit claim 12, wherein a rotary drive is assigned to the tool receptacle, with which the tool receptacle is configured to be positioned rotatably about the stroke axis relative to the housing, wherein the alignment of the at least one cutting or punching tool of the stroke axis is configured to be changed in accordance with the rotational position of the tool receptacle.

20. The punching unit of claim 12, wherein a rotary drive is assigned to the die unit, with which a die that receives the respectively activated cutting or punching tool and is complementary to the activated cutting or punching tool is configured to be positioned rotatably about the stroke axis relative to the housing, wherein the die is configured to be positioned in accordance with the alignment and positioning of the activated cutting or punching tool of the stroke axis.
